(19) United States
(12) Patent Application Publication
(10) Pub. No.: US 2010/0106682 A1
(43) Pub. Date: Apr. 29, 2010

(54) Database Index

(75) Inventor: Duncan Pauly, Wiltshire (GB)

Correspondence Address: KENYON & KENYON LLP, RIVERPARK TOWERS, SUITE 600, 333 W. SAN CARLOS ST., SAN JOSE, CA, 95110, US

(73) Assignee: COPPEREYE LIMITED, Wiltshire (GB)

(21) Appl. No.: 12/529,328

(22) PCT Filed: Feb. 18, 2008
(86) PCT No.: PCT/GB08/00565

§ 371 Date: Jan. 5, 2010

(30) Foreign Application Priority Data
Mar. 1, 2007 (GB) 0704018.1

(51) Int. Cl. G06F 17/30

(52) U.S. Cl. 707/609; 707/769; 707/741; 707/E17.002; 707/E17.005; 707/E17.014

(57) ABSTRACT

A method of maintaining a database index. The index comprises a hierarchical structure of conclusion sets arranged in a series of levels. The method comprising: inserting an “Insert” conclusion set entry into a high level conclusion set; migrating the “Insert” conclusion set entry from the high level conclusion set to a low level conclusion set; deleting the “Insert” conclusion set entry by inserting a “Delete” conclusion set entry into the high level conclusion set; and migrating the “Delete” conclusion set entry from the high level conclusion set to the low level conclusion set whilst maintaining the conclusion set entries in chronological order of insertion within each conclusion set and between levels of conclusion sets.

### FIELD OF THE INVENTION

The present invention relates to a database index and system, a method of maintaining a database index, and a method of querying a database index with a key.

### BACKGROUND OF THE INVENTION

WO 02/069185 describes a database index in which conclusion sets are arranged in a hierarchical structure, and conclusion set entries are migrated to lower levels when each conclusion set fills up.

This index performs well if a new conclusion set entry is inserted, because the new entry is inserted into the highest level conclusion set of the index. However, the index performs less well if a conclusion set entry is to be deleted, because the specific conclusion set containing the entry must be located and updated, and this conclusion set may be at a relatively low level of the hierarchy. With entries being deleted in random order, the delete operation will need to address random conclusion sets and incur significant disk input/output.

### SUMMARY OF THE INVENTION

A first aspect of the invention provides a method of maintaining a database index, the index comprising a hierarchical structure of conclusion sets arranged in a series of levels, the method comprising:
inserting an “Insert” conclusion set entry into a high level conclusion set;
migrating the “Insert” conclusion set entry from the high level conclusion set to a low level conclusion set;
deleting the “Insert” conclusion set entry by inserting a “Delete” conclusion set entry into the high level conclusion set; and
migrating the “Delete” conclusion set entry from the high level conclusion set to the low level conclusion set whilst maintaining the conclusion set entries in chronological order of insertion within each conclusion set and between levels of conclusion sets.

The first aspect of the invention makes delete operations more efficient, since the “Delete” conclusion set entry can be inserted into the high level conclusion set without requiring the low level conclusion set to be updated. Typically the “Insert” entry will remain in the low level conclusion set, but the “Delete” entry causes a subsequent query to return no result associated with that entry. Therefore the “Delete” entry effectively deletes the “Insert” entry (at least for the purpose of a subsequent query).

Typically each conclusion set contains a watermark, and migration of the “Insert” conclusion set entry and the “Delete” conclusion set entry is performed by:
copying the conclusion set entry from the high level conclusion set to the low level conclusion set;
reading a watermark of the low level conclusion set;
appending the copied conclusion set entry to the low level conclusion set above its watermark;
lowering the watermark of the high level conclusion set; and
raising the watermark of the low level conclusion set.

The watermark of a conclusion set may be raised or lowered by moving a pointer from the old watermark to the new watermark.

As well as containing “Insert” and “Delete” entries, the database may also contain transaction operation identifiers. In this case the method further comprises:
inserting a first transaction operation identifier into the high level conclusion set;
migrating the first transaction operation identifier from the high level conclusion set to two or more low level conclusion sets within a single level of the hierarchical structure;
inserting a second transaction operation identifier into the high level conclusion set, the second transaction operation identifier being associated with the first transaction operation identifier and performing a transaction on all “Insert” and “Delete” conclusion set entries between the first and second identifiers; and
migrating the second transaction operation identifier from the high level conclusion set to the two or more low level conclusion sets whilst maintaining the transaction operation identifiers in chronological order of insertion within each conclusion set and between levels of conclusion sets.

The second identifier may for example commit, drop, undo, or roll back all “Insert” and “Delete” conclusion set entries between the first and second identifiers.

Typically the high level conclusion set contains two or more conclusion set entries, and during each migration step the two or more conclusion set entries are split and migrated to two or more low level conclusion sets within a single level of the hierarchical structure.

The “Delete” entry may include only an associated key, or may also contain data specifying the “Insert” entry. This enables the “Delete” entry to delete only the specified entry, leaving intact other “Insert” entries associated with the key.

A further aspect of the invention provides a method of querying a database index with a key, the index comprising a hierarchical structure of conclusion sets arranged in a series of levels, each conclusion set containing one or more conclusion set entries, the conclusion set entries being in chronological order of insertion within each conclusion set and between levels of conclusion sets, the method comprising:
navigating the database index to retrieve a “Delete” conclusion set entry which is associated with the key; and
returning no result associated with at least one “Insert” conclusion set entry which is associated with the key and chronologically earlier than the “Delete” conclusion set entry.

The query method may only navigate to the “Delete” conclusion set entry, without navigating further. However more preferably the index is navigated to its lowest level.

This enables a further “Insert” conclusion set entry associated with the key to be retrieved, and an associated result returned.

A further aspect of the invention provides a computer program product for causing a data processor to maintain and/or query a database index by the method of the first and/or further aspect of the invention.

A further aspect of the invention provides a database index maintained by the method of the first aspect of the invention.

A further aspect of the invention provides a database system comprising: an index maintained by the method of the first aspect of the invention; and a query engine configured to query the index.

### BRIEF DESCRIPTION OF THE DRAWINGS

Embodiments of the invention will now be described with reference to the accompanying drawings, in which:

FIG. 1a shows a decision graph and a plurality of conclusion sets;

FIG. 1b shows a computer and storage medium;

FIG. 2 shows a first example of the contents of the conclusion sets;

FIG. 3a-3g show further examples of the contents of the conclusion sets;

FIG. 4-6 show the conclusion sets with digital watermarks and pointers; and

FIG. 7 shows an alternative index in which the conclusion sets are distributed through the index structure.

### DETAILED DESCRIPTION OF EMBODIMENT(S)

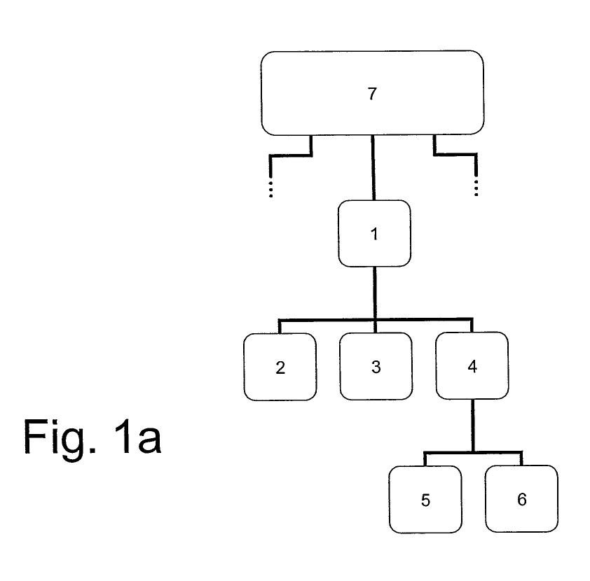

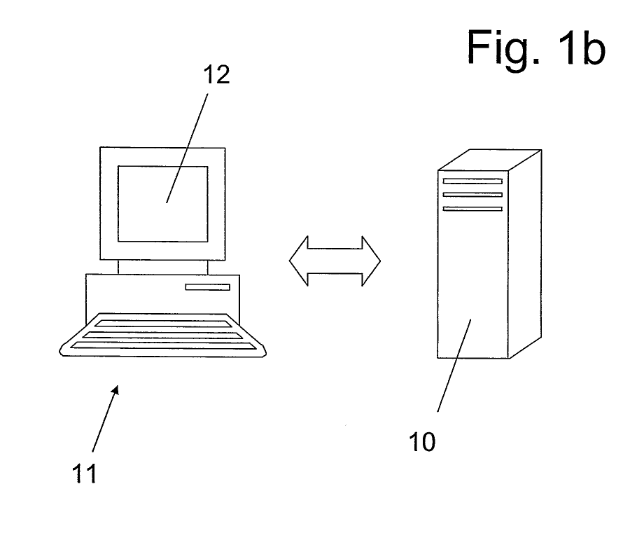

The index shown in FIG. 1a comprises a decision graph 7 and a plurality of conclusion sets 1-6 arranged in a tree-structure as shown. Each conclusion set is reached by one, and only one, path through the decision graph. Each conclusion set then either contains pointers relevant entries in a data store (not shown), or contains the data itself.

The index is stored on a storage medium 10 shown in FIG. 1b, and maintained by an index management engine running on a computer 11. The computer 11 also runs a query engine which navigates the index to return query results as described below.

The decision graph 7 comprises a plurality of decision nodes at which a search key is matched with decision criteria in order to define which path should be taken through the decision graph. The internal organization of the keys within the decision graph does not constitute part of the present invention, and consequently need not be described in detail here. In general terms, the decision graph 7 contains a series of nodes in a similar tree-structure to the conclusion sets, but the nodes do not contain pointers or data. Prior art indexing structures, such as a B-tree index or an index as described in WO 02/044940, may be utilized within the decision graph.

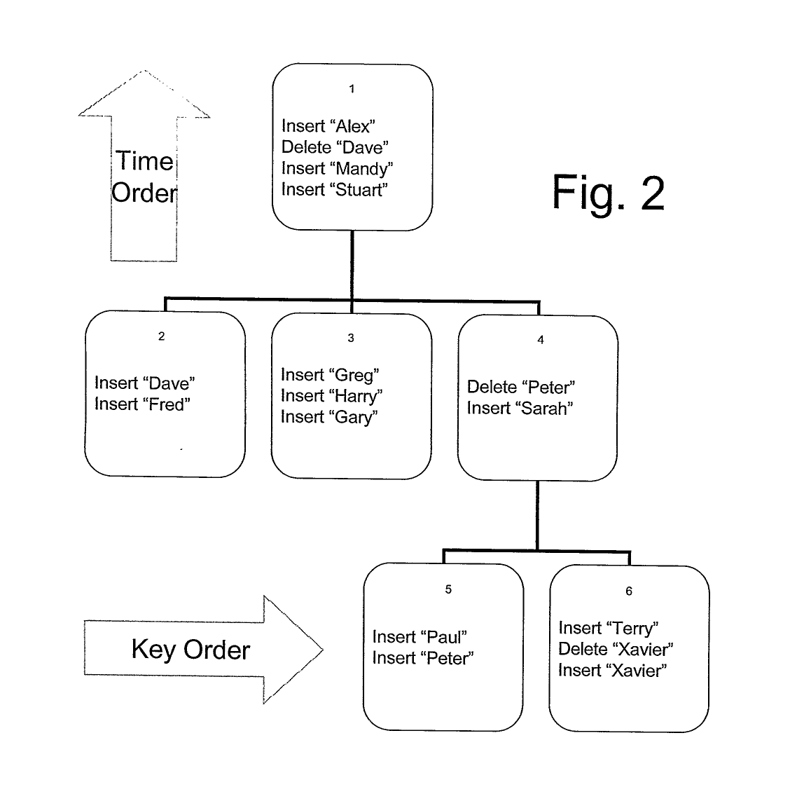

The conclusion sets 1-6 are arranged in a hierarchical structure as described in further detail in WO 02/069185, the contents of which is incorporated herein by reference. Only six conclusion sets 1-6 are shown in FIG. 2, and it should be noted that these form only a small part of the structure of conclusion sets.

In the arrangement illustrated there are three levels of conclusion sets with level one (containing conclusion set 1) being the hierarchically most significant, and level three (containing conclusion sets 5 and 6) being the hierarchically least significant.

Suppose now that it is desired to insert an entry into the database. The decision graph 7 is navigated in accordance with the key for the entry to discover which conclusion set the entry belongs to. This results in a single level one conclusion set being identified. Advantageously the level one conclusion sets are held by the storage medium 10 in fast memory (that is, either a fast mass media storage device or better still semiconductor memory) such that the time overhead in inserting data into a level one conclusion set is small compared to the time required to insert data into one of the lower level conclusion sets. Indeed, if the level one conclusion sets are held in semiconductor memory then there is no I/O cost incurred in writing to them.

During time, as more and more data is inserted into the database, the conclusion set 1 begins to fill. Once the number of entries in the conclusion set 1 reaches a predetermined number, corresponding to the conclusion set being full, the entries in the conclusion set 1 are migrated down to the immediately subordinate conclusion sets 2-4 which belong to level two of the hierarchical structure.

The decision on which of the lower level conclusion sets 2-4 receives an entry from the level one conclusion set 1 is determined by continuing the navigation rules which exist within the decision graph 7. Thus, for example, if the decision graph 7 has rules based on individual bit values in increasing order of bit number, then the rule for migrating data from the top level conclusion set to the second level conclusion set 2-4 will use the next bit in the search key to determine which of the conclusion sets 2-4 should be recipient for each item of data. During this migration process, the conclusion set 1 becomes fully emptied.

The process of migration from an Nth level to an N+1th level occurs at each level within the conclusion set hierarchy as each conclusion set therein fills up. Thus once conclusion set 4 becomes full, it in turn migrates its data to its subordinate conclusion sets 5 and 6 on the third level of the hierarchy. In this example, the third level is the lowest level of the hierarchy and the conclusion sets 5 and 6 are not able to pass their data down to subordinate conclusion sets. However, if four or more levels of conclusion sets were included within this hierarchical structure, then the conclusion sets 5 and 6 could indeed migrate their data to their own subordinate conclusion sets as and when they became full. It can be expected, assuming a random distribution of keys, that during migration half of the entries in the conclusion set 4 will go to conclusion set 5 and the other half will go to conclusion set 6. This process is repeated at each level of migration such that all of the entries are substantially equally distributed throughout the lower level conclusion sets.

When querying the index for a specific key, each conclusion set in a single path running to the very least significant conclusion set must be queried. Thus, if the hierarchical structure of conclusion sets consists of L levels, then L conclusion sets must be queried in order to find all results that match the key, since the key may reside at any level within the hierarchy. Thus this indexing scheme increases throughput, or the ease at which entries may be added to the index, at the expense of degrading query performance. However, this trade-off is acceptable in any application which has to accept large amounts of data but queries it infrequently. An example of such an application is a fraud detection system that has to load every transaction, but only queries those transactions relating to suspicious activity.

FIG. 2 gives a first example of the contents of conclusion sets 1-6 in detail. Each conclusion set contains one or more conclusion set entries, and the conclusion set entries are arranged in chronological order of insertion within each conclusion set and between levels of the hierarchical structure. In the example of FIG. 2, each conclusion set contains a maximum of four entries, arranged in a list in reverse chronological order of insertion (that is, with the most recently inserted entry at the top of the list). Thus for example the level one conclusion set 1 contains a list of four entries:
Insert “Alex”
Delete “Dave
Insert “Mandy”
Insert “Stuart”

In this example, the [Insert “Stuart”] entry has been inserted first, and the [Insert “Alex”] entry has been inserted most recently.

When migrating the entries from a higher level to a lower level, the entries are moved in their original chronological order and appended to the lower conclusion sets to preserve time order. Thus every conclusion set (including the level one conclusion set 1) is only appended to (or completely cleared) as part of a migration.

Optionally, each conclusion set entry may also record the time of insertion of that entry. This enables the index management engine to easily arrange the conclusion set entries in chronological order of insertion within each conclusion set and between levels of conclusion sets. It also enables the query engine to query the index at a historic point in time, by ignoring all entries which have been entered subsequent to that point in time.

Each entry in the conclusion sets 1-6 contains a key (for instance the key “Alex”); and an entry operation identifier (for instance “Insert” or “Delete”). “Insert” entries also contain property data (that is, data associated with the key, or a pointer to a relevant entry in the data store which contains data associated with the key) which is not shown in FIG. 2 for purposes of clarity. “Delete” entries do not contain such property data.

Entries are distributed amongst conclusion sets across each level in an alphabetical key order as shown in FIG. 2. Thus for example the second level contains keys “Dave” and “Fred” in the left-hand conclusion set 2 (being the first two keys in alphabetical order) and keys “Peter” and “Sarah” in the right-hand conclusion set 4 (being the last two keys in alphabetical order).

The entries in level three conclusion sets 5,6 were entered first into level one and have migrated through level two to level three, following the migration process described above.

The function of the “Insert” and “Delete” entry operation identifiers will now be described with reference to three examples.

### EXAMPLE 1

A key “Harry” is queried. The query engine navigates the index in response to the query and arrives at conclusion set 3 via conclusion set 1. Note that both conclusion sets 1 and 3 must be queried in order to find all results that match the key, since the key may reside at any level within the hierarchy. This retrieves no entries from conclusion set 1, but does retrieve one entry from conclusion set 3.

The query engine then reads the entry operation identifier associated with the retrieved entry in the conclusion set 3. In this case, it is an “Insert” entry operation identifier. Therefore the query engine returns a result (that is, the data pointed to by the entry [Insert “Harry”] in conclusion set 3) and that result is displayed on the screen 12 of the computer 11 and/or stored for later analysis.

### EXAMPLE 2

A key “Dave” is queried. The index is navigated to conclusion set 2 via conclusion set 1. This retrieves one relevant entry from conclusion set 1, and one relevant entry from conclusion set 2.

The relevant entry in conclusion set 2 contains the “Insert” entry operation identifier. The relevant entry in conclusion set 1 contains the “Delete” entry operation identifier. Because the “Delete” entry in conclusion set 1 is more chronologically recent than the “Insert” entry in conclusion set 2, the query returns no result associated with the “Insert” conclusion set entry in conclusion set 2. In other words, the “Delete” entry has the effect of deleting the “Insert” entry in conclusion set 2 from memory without having to incur the cost of actively updating conclusion set 2.

### EXAMPLE 3

A key “Xavier” is queried. The index is navigated and queried to conclusion set 6 via conclusion sets 1 and 4. Conclusion set 6 contains two relevant entries. Because the “Delete” entry in conclusion set 6 is more recent than the “Insert” entry in conclusion set 6, the query returns no result.

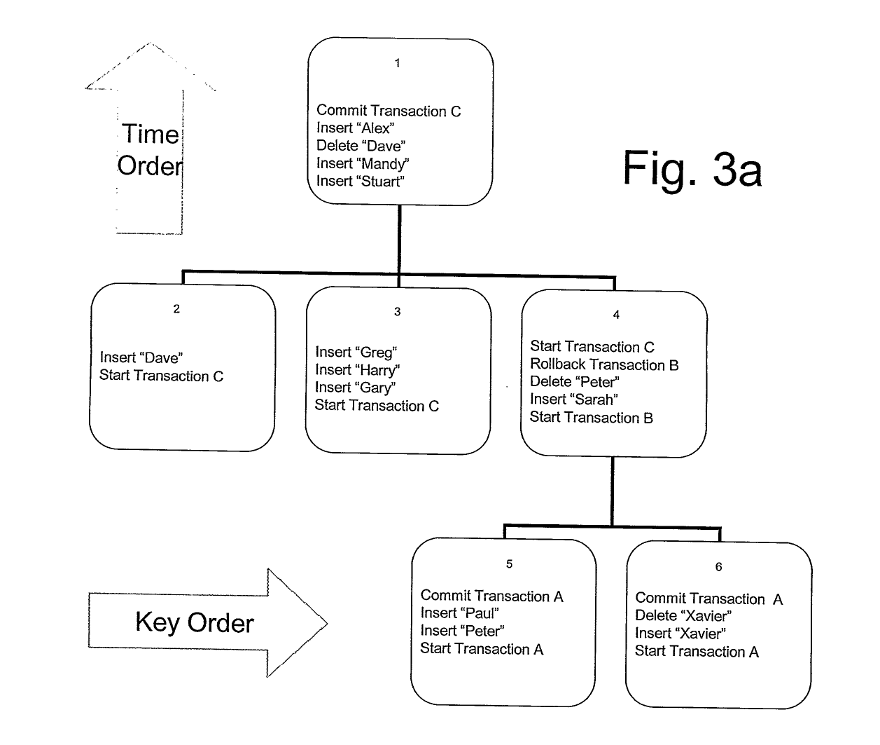

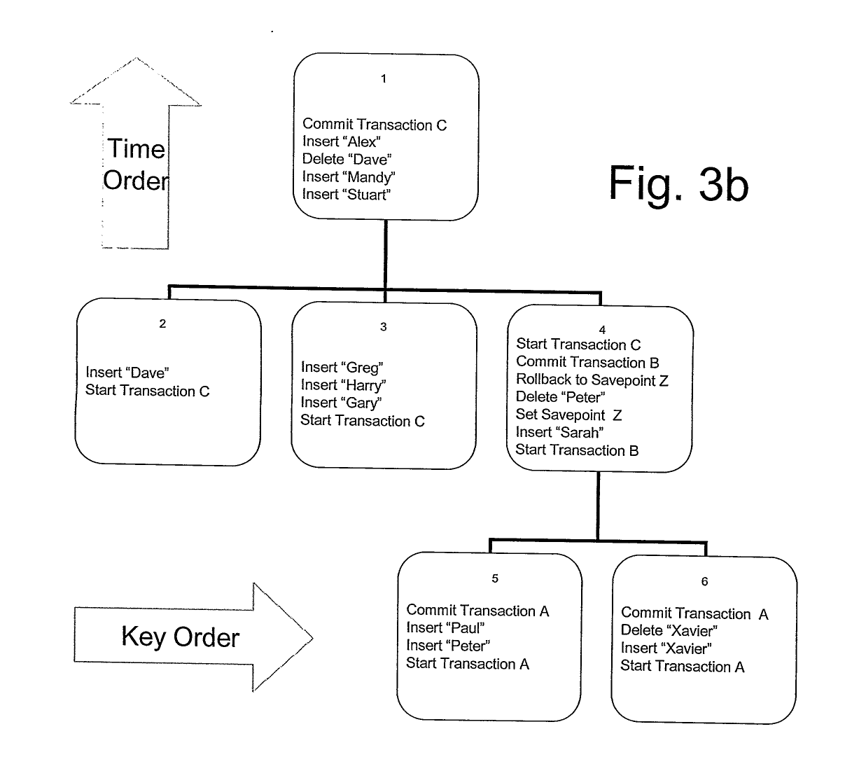

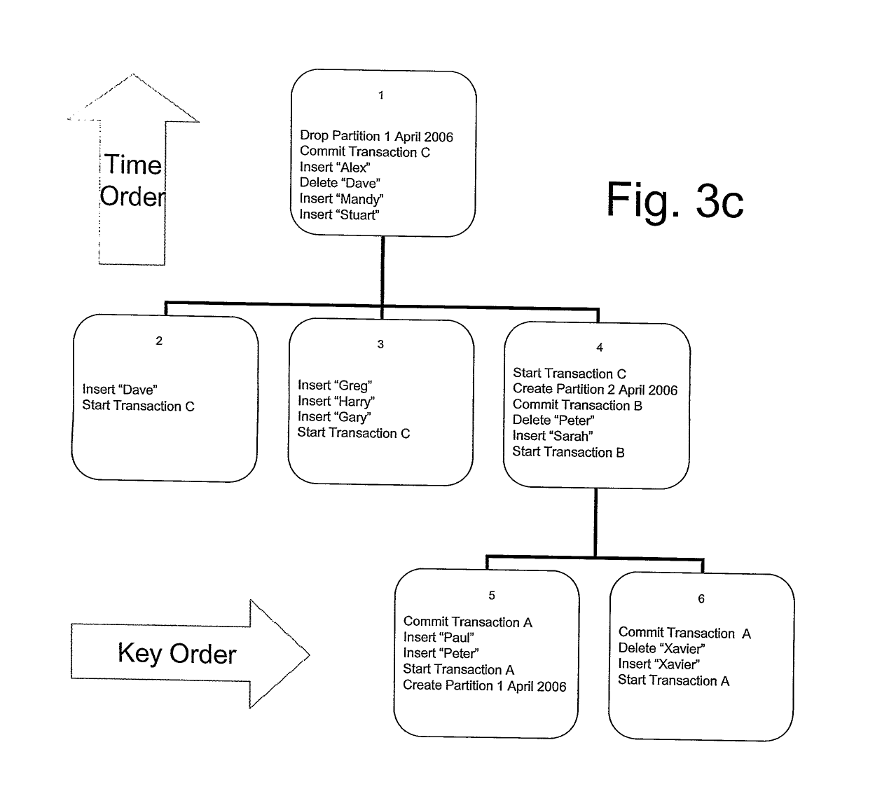

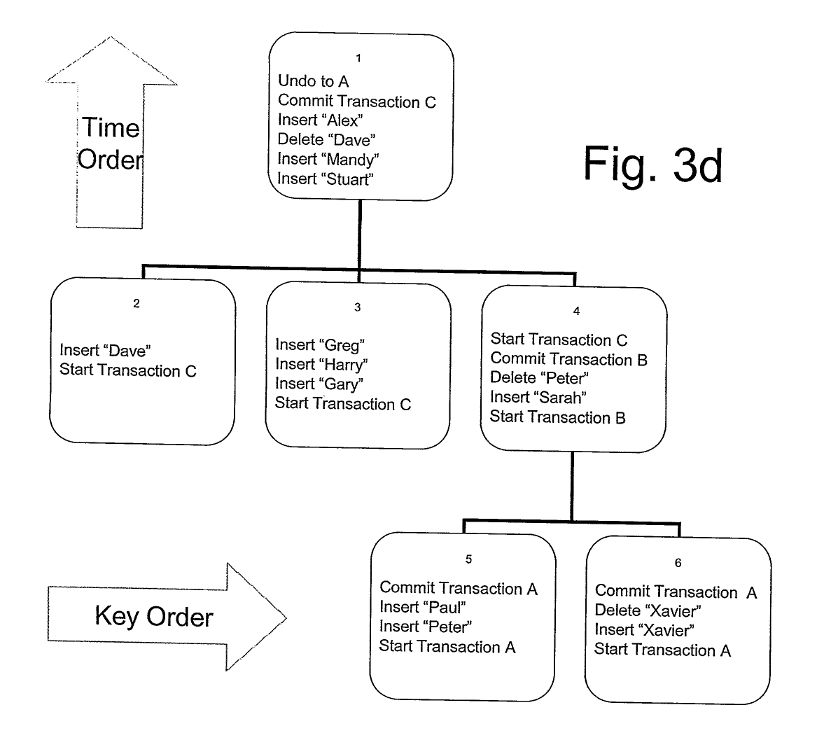

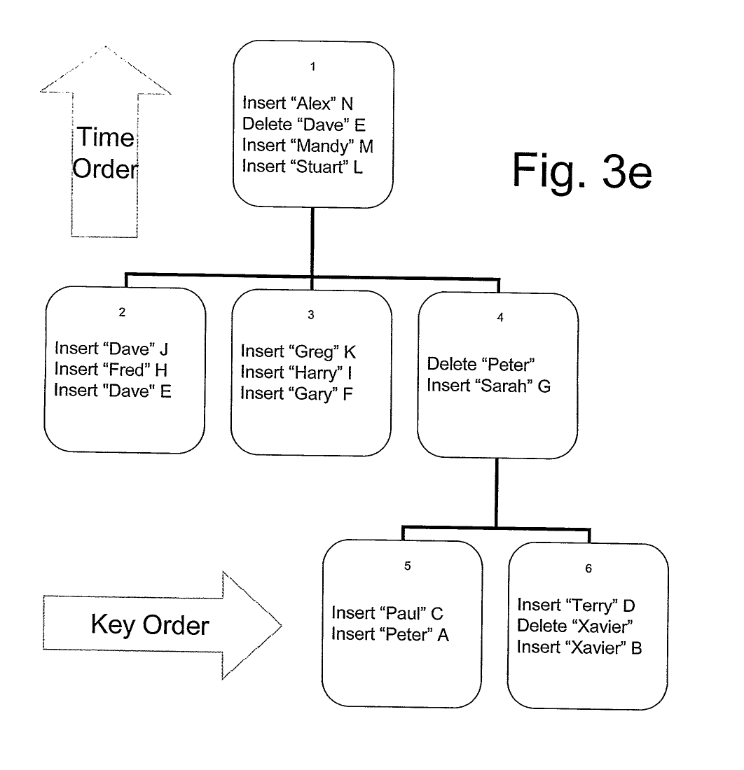

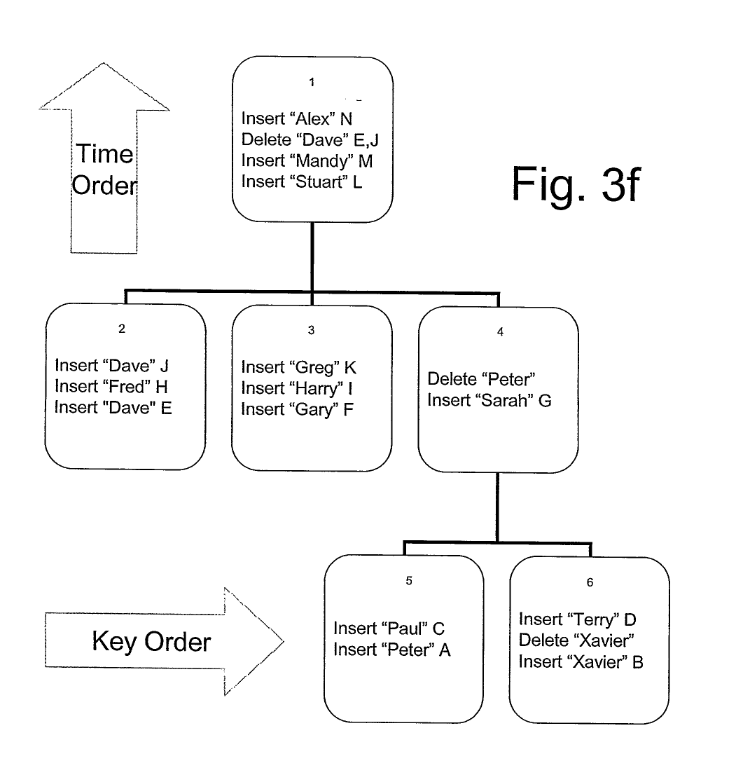

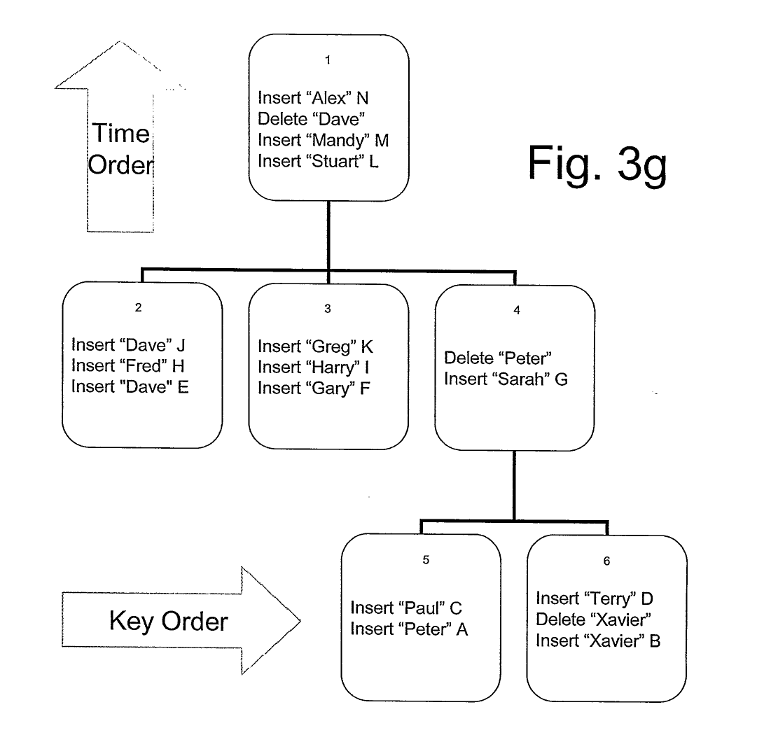

FIG. 3a gives a second example of the contents of conclusion sets 1-6 in detail. Each conclusion set contains a maximum of five entries. In the example of FIG. 3, as well as containing entries with entry operation identifiers (“Insert” and “Delete”), some of the conclusion sets also includes entries with transaction operation identifiers (“Start Transaction”, “Commit Transaction” and “Rollback Transaction”), and transaction identifiers (for instance “A”, “B” or “C”). Thus the entry [Start Transaction A] relates to a “Start” operation for transaction “A”.

The functions of these entries will now be described with reference to three examples.

### EXAMPLE 4

A key “Peter” is queried. The index is navigated to conclusion set 5 via conclusion sets 1 and 4. A [Rollback Transaction B] entry is found in conclusion set 4. As a result, all entries between [Rollback Transaction B] and [Start Transaction B] are ignored. Hence the [Delete “Peter”] entry in conclusion set 4 is ignored. The relevant entry in conclusion set 5 contains the “Insert” entry operation identifier. Therefore the query returns the data pointed to by the entry [Insert “Peter”] in conclusion set 5.

### EXAMPLE 5

A key “Alex” is queried. The index is navigated to conclusion set 2. A [Commit Transaction C] entry is found in conclusion set 1. As a result, all entries between [Start Transaction C] in conclusion set 2 and [Commit Transaction C] in conclusion set 1 are valid. The relevant entry in conclusion set 1 contains the “Insert” entry operation identifier. Therefore the query returns the data pointed to by the entry [Insert “Alex”] in conclusion set 1.

Note that there is a [Start Transaction C] entry in each three level two conclusion set 2-4, because an operation that is for a whole transaction is independent of any key value and therefore has to be migrated in all possible key directions. For example, Dave and Gary were both inserted in transaction C but those keys follow different paths and the start of transaction C needs to be propagated in both directions. Because the index management engine does not necessarily know what keys are going to be associated with a transaction, transaction based operations need to be propagated in all possible directions.

### EXAMPLE 6

A key “Paul” is queried. The index is navigated to conclusion set 5 via conclusion sets 1 and 4. [Start Transaction A] and [Commit Transaction A] entries are found in conclusion sets 5 and 6. As a result, all entries between [Start Transaction A] and [Commit Transaction A] are valid. The relevant entry in conclusion set 5 contains the “Insert” entry operation identifier. Therefore the query returns the data pointed to by the entry [Insert “Paul”] in conclusion set 5.

### EXAMPLE 7

FIG. 3b gives a third example of the contents of conclusion sets 1-6 in detail. In the example of FIG. 3b, conclusion set 4 includes “Set Savepoint” and “Rollback to Savepoint” transaction operation identifiers.

The functions of these entries are as follows. A key “Peter” is queried. The index is navigated to conclusion set 5 via conclusion sets 1 and 4. A [Rollback to Savepoint Z] entry is found in conclusion set 4. As a result, all entries between [Rollback to Savepoint Z] and [Set Savepoint Z] are ignored. Hence the [Delete “Peter”] entry in conclusion set 4 is ignored. The relevant entry in conclusion set 5 contains the “Insert” entry operation identifier. Therefore the query returns the data pointed to by the entry [Insert “Peter”] in conclusion set 5.

### EXAMPLE 8

FIG. 3c gives a fourth example of the contents of conclusion sets 1-6 in detail. In the example of FIG. 3c, conclusion sets 1,4 and 5 contain Logical Partition transaction operation identifiers, which operate as follows.

Conclusion set 5 contains an entry [Create Partition 1 Apr. 2006]. Conclusion set 4 contains an entry [Create Partition 2 Apr. 2006]. The entry [Drop Partition 1 Apr. 2006] in conclusion set 1 causes all entries for that logical partition to be dropped. In other words, all entries between the entry [Create Partition 1 Apr. 2006] and the entry [Create Partition 2 Apr. 2006] are dropped. Therefore a query for “Paul” or “Sarah” will return no result.

Dropping the partition avoids the need to explicitly delete individual entries within that partition, and allows a mass drop of data for data management and expiry.

### EXAMPLE 9

FIG. 3d gives a fifth example of the contents of conclusion sets 1-6 in detail. In the example of FIG. 3d, conclusion set 1 contains an [Undo to A] transaction operation identifier, which forces the index to revert back to the end of Transaction A and queries can only see Peter and Paul. This can be used to recover the index state to a previous point in time to back out recent transactions that are deemed invalid or unwanted.

### EXAMPLE 10

FIG. 3e gives a sixth example of the contents of conclusion sets 1-6 in detail. FIG. 3e is similar to FIG. 2, except in this case the property data associated with the “Insert” entries is shown. In this case, the property data associated with each “Insert” entry is a pointer to a relevant entry in the data store which contains data associated with the key. Thus for example the entry [Insert “Peter” A] includes a pointer for key “Peter” to an entry A in the data store, and the entry [Insert “Dave” E] includes a pointer for key “Dave” to an entry E in the data store.

Note also that there are two “Insert” entries for key “Dave” in conclusion set 2, namely:
[Insert “Dave” J] which points to an entry J in the data store; and
[Insert “Dave” E] which points to an entry E in the data store.

In most cases, as in FIG. 2, the “Delete” entries contain no property data, but only refer to a key. For instance the entry [Delete “Peter”] has the effect of dropping the [Insert “Peter” A] entry from conclusion set 5.

However, since there are two “Insert” entries for key “Dave”, the “Delete” entry in conclusion set 1 must specify which “Insert” entry is to be dropped. Thus in this case the [Delete “Dave” E] drops the earlier [Insert “Dave” E] entry but not the later [Insert “Dave” J] entry.

Thus without the [Delete “Dave” J] entry, a query for key “Dave” would return two results. The [Delete “Dave” J] entry causes such a query to return only one result (i.e. it returns the entry E in the data store).

### EXAMPLE 11

FIG. 3f gives a seventh example of the contents of conclusion sets 1-6 in detail. FIG. 3f is similar to FIG. 3e, except in this case the [Delete “Dave” E,J] specifies both [Insert “Dave”] entries. That is, the [Delete “Dave” E,J] drops both the [Insert “Dave” J] and the [Insert “Dave” E] entry and thus causes a query for “Dave” to return no result.

### EXAMPLE 12

FIG. 3g gives an eighth example of the contents of conclusion sets 1-6 in detail. FIG. 3g is similar to FIG. 3f, except in this case the [Delete “Dave”] entry does not specify any particular [Insert “Dave”] entry. Therefore the [Delete “Dave”] drops the most recent entry [Insert “Dave” J] but does not drop any earlier [Insert “Dave”] entries.

### EXAMPLE 13

In an alternative example, in the case of FIG. 3g the [Delete “Dave”] entry may have the effect of dropping all [Insert “Dave”] entries in the index, instead of only deleting the most recent entry.

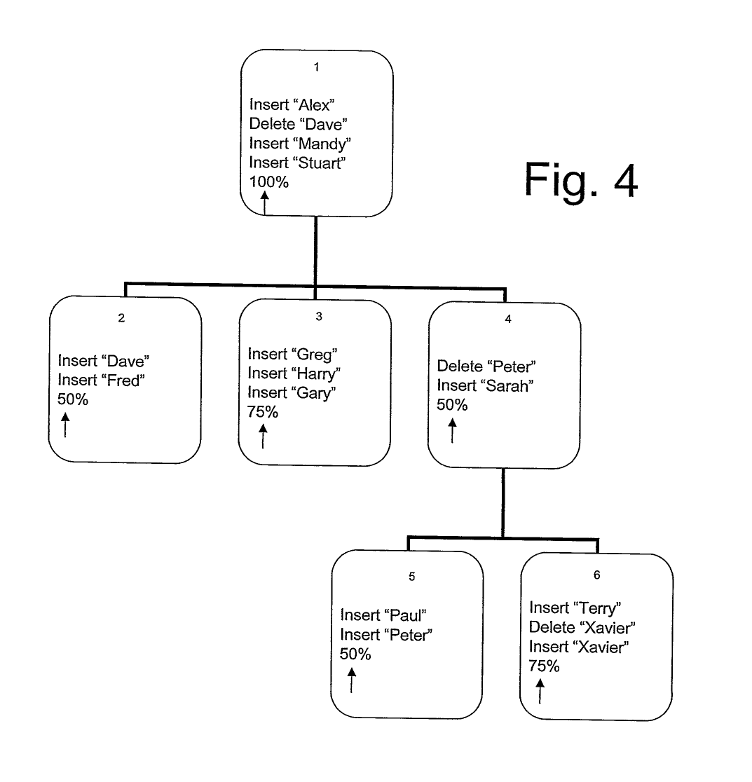

An improved method of migrating data using digital watermarks is shown in FIGS. 4-6.

FIG. 4 shows conclusion sets containing the same entries as in FIG. 2. However in this example each conclusion set 1-6 also contains a digital watermark, and a pointer. The watermark is indicative of how full the conclusion set is (compared with the maximum of four entries). Thus because conclusion set 1 is full, its watermark is 100%. Conclusion set 5 is only half full so it has a watermark of 50%, and conclusion set 3 is three-quarters full so it has a watermark of 75%.

In all conclusion sets in FIG. 4, only a single watermark is shown for each conclusion set, and the pointer points to that watermark.

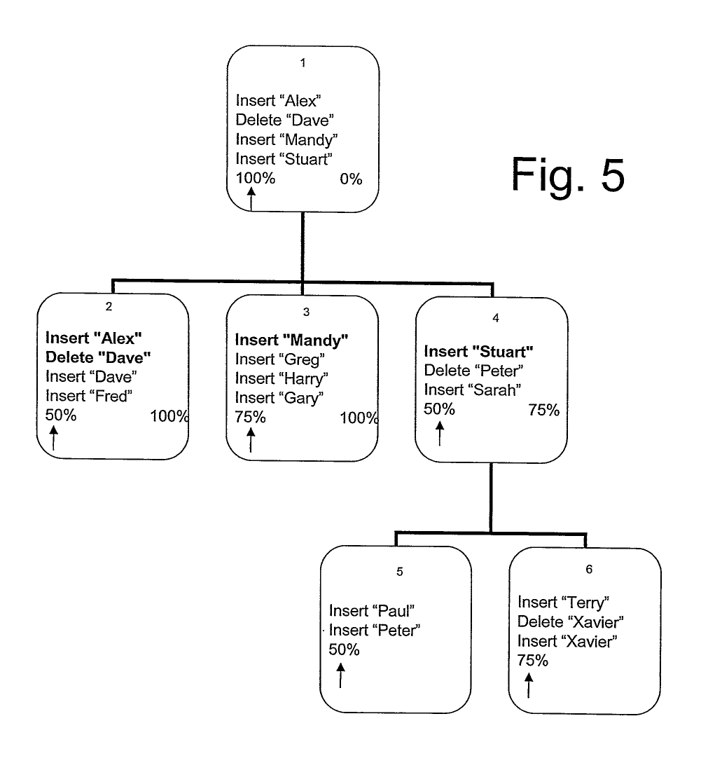

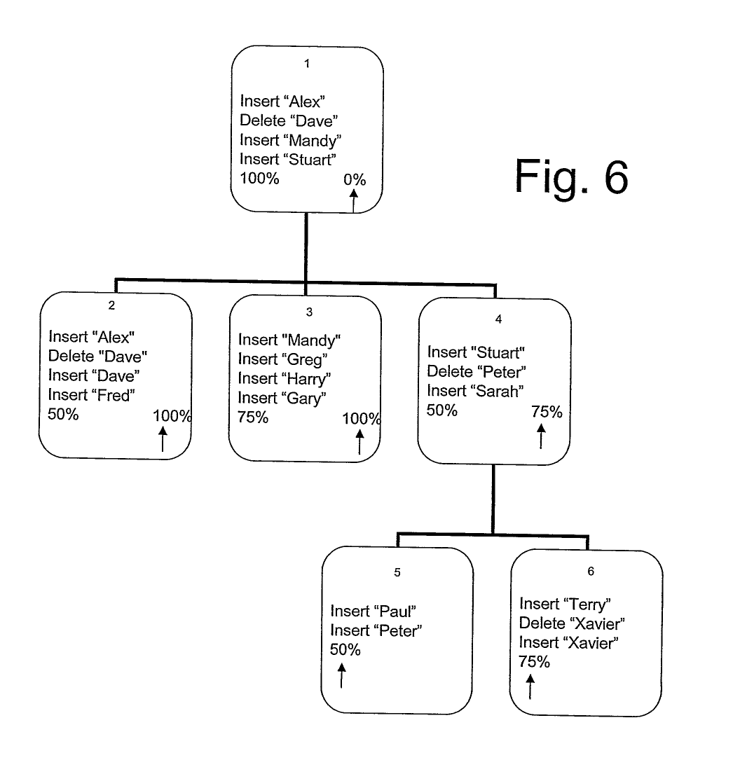

If a new entry is to be made into conclusion set 1, then because the conclusion set is full, the contents of that conclusion set must be migrated down to the next level. The migration process is shown in FIGS. 5 and 6. In a first step shown in FIG. 5, the four entries are copied from conclusion set 1 and appended to the conclusion sets 2-4 above their respective watermarks. Thus for example conclusion set 2 has a watermark of 50%, so the two migrated entries (shown in bold in FIG. 2) are written to the conclusion set 2 above the two existing entries. In contrast, conclusion set 3 has a watermark of 75%, so the one migrated entry (shown in bold in FIG. 2) is written to the conclusion set 3 above the three existing entries.

Note that the migrated entries are distributed amongst the level two conclusion sets 2-4 in accordance with the navigation rules associated with the decision graph 7.

After the entries have been migrated, a new watermark is written to conclusion sets 1-4. Thus conclusion sets 1-4 have old watermarks 100%, 50%, 75% and 50% respectively and new watermarks 0%, 100%, 100% and 75% respectively. At the stage shown in FIG. 5, the pointers remain pointing at the old watermarks. Note also that the entries in conclusion set 1 have not been deleted. Therefore in the event of a failure during the migration process (for instance a hardware failure), it is possible to roll back the migration process since no information has been lost or corrupted.

Once migration is complete as shown in FIG. 5, the pointers are moved to the positions shown in FIG. 6 in which they point at the new watermarks. This implements the migration process “atomically”. The conclusion set 1 is now effectively “empty” (since its watermark has been lowered to 0%) although its entries have not yet been dropped from memory. When a new entry is written to conclusion set 1, it overwrites the bottom entry [Insert “Stuart”] and the watermark is updated to 25%. The watermarks in conclusion sets 2-4 have been raised, so subsequent migrations append entries above their respective raised watermarks. When the watermarks of any of the conclusion sets 2-4 in level two reach 100%, then in the next migration process they are emptied to level three.

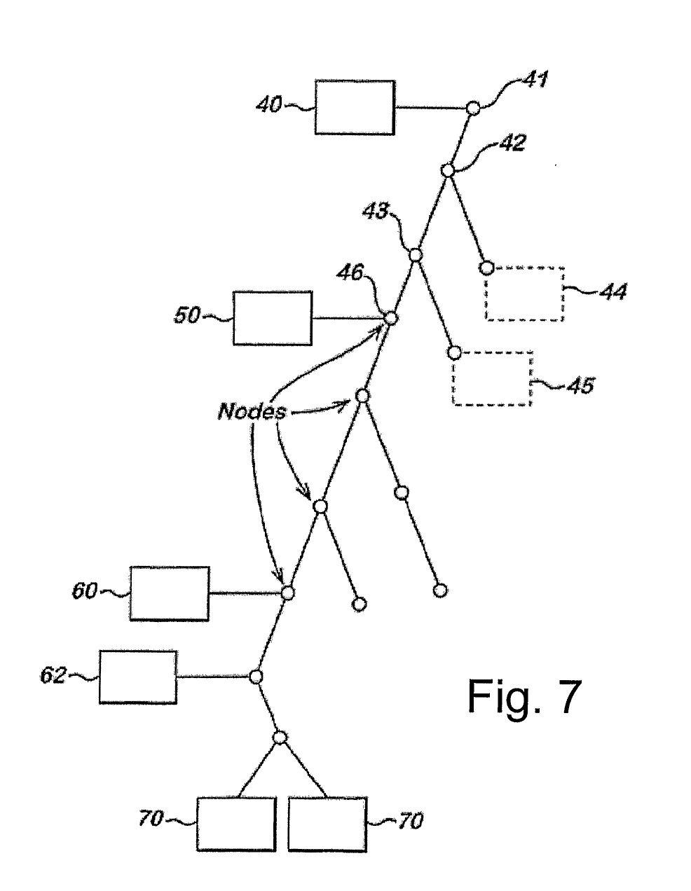

In the examples above, the conclusion sets 1-6 form a contiguous tree-structure at the lowest level of the database structure, below the decision graph 7. However in an alternative embodiment shown in FIG. 7, the conclusion sets are distributed through the index structure, and extend into the decision graph. Note that the conclusion sets 40,50,60,62,70 shown in FIG. 7 may contain entry operation identifiers, transaction operation identifiers and/or watermarks as described above with reference to FIGS. 1-6.

FIG. 7 illustrates a portion of a decision graph wherein the decision graph has been constructed with an inter-conclusion set distance Q=3, such that a conclusion set 40, 50 and 60 is allowed at every third branching node. Suppose that we join the database at a time where the data contained therein is such that conclusion set 40 has just been created, but conclusion sets 50 and 60 have not yet been created.

During use, data is added to the database, and the content of that data is such that the conclusion set 40 becomes full. Once this occurs, the information within the conclusion set 40 is redistributed en-masse by creating the lower level node 42, optionally node 43, and migrating the data from conclusion set 40 into new temporary conclusion sets 44 and 45 shown in outline in FIG. 7. Filling of the database then continues until conclusion set 40 fills again. It then attempts to redistribute its contents to its subordinate conclusion sets. This in turn may make one of them full and so it becomes necessary to remove the full temporary conclusion set from the exit path of node 42 and to insert one or more further nodes and additional conclusion sets as required.

This can continue until such time as conclusion set 50 is established as an exit to node 46. At this time, the inter-conclusion set distance between conclusion sets 40 and 50 then corresponds to the distance Q specified by the designer or user of the database. Under these conditions, a check is made to see if an intermediate conclusion set exists in the decision path extending between nodes 41 and 46. Any conclusion sets in this decision path are removed and their contents are moved to conclusion set 50.

As conclusion set 50 fills up, new temporary conclusion sets may be created until such time as conclusion set 60 is created, and so on. Thus it becomes possible for the inter-conclusion set distance between conclusion sets which are not in the lowermost layers of the decision index to be held at a specified inter-conclusion set spacing. In the arrangement shown in FIG. 7 conclusion sets 62 and 70 represent the lowermost layers of the database, and indeed conclusion sets 60, 62 and 70 can represent levels one, two and three of conclusion sets in the arrangement shown in FIG. 2.

As before, the mass redistribution of conclusion set entries to lower level conclusion sets results in a reduced disc input/output penalty compared with the writing of individual items of data. Furthermore, the data entry cost into the structure shown in FIG. 7 is further reduced since an entry is inserted into the first conclusion set found. Each entry from a full conclusion set is then moved to the appropriate lower level conclusion set which is found by following the decision graph from the full conclusion set via the entry to be moved.

When querying the database, the decision path for the relevant key has to be navigated right to the lowermost level conclusion set and each conclusion set found en-route must also be queried as it may contain data matching the search key criteria.

Although the invention has been described above with reference to one or more preferred embodiments, it will be appreciated that various changes or modifications may be made without departing from the scope of the invention as defined in the appended claims.

1. A method of maintaining a database index, the index comprising a hierarchical structure of conclusion sets arranged in a series of levels, the method comprising:
inserting an “Insert” conclusion set entry into a high level conclusion set;
migrating the “Insert” conclusion set entry from the high level conclusion set to a low level conclusion set;
deleting the “Insert” conclusion set entry by inserting a “Delete” conclusion set entry into the high level conclusion set; and
migrating the “Delete” conclusion set entry from the high level conclusion set to the low level conclusion set whilst maintaining the conclusion set entries in chronological order of insertion within each conclusion set and between levels of conclusion sets.

2. The method of claim 1, wherein each conclusion set contains a watermark, and migration of the “Insert” conclusion set entry and the “Delete” conclusion set entry is performed by:
copying the conclusion set entry from the high level conclusion set to the low level conclusion set;
reading a watermark of the low level conclusion set;
appending the copied conclusion set entry to the low level conclusion set above its watermark;
lowering the watermark of the high level conclusion set; and
raising the watermark of the low level conclusion set.

3. The method of claim 2 wherein each conclusion set contains an old watermark and a new watermark, and the watermark of a conclusion set is raised or lowered by moving a pointer from the old watermark to the new watermark.

4. The method of claim 1, further comprising:
inserting a first transaction operation identifier into the high level conclusion set;
migrating the first transaction operation identifier from the high level conclusion set to two or more low level conclusion sets within a single level of the hierarchical structure;
inserting a second transaction operation identifier into the high level conclusion set, the second transaction operation identifier being associated with the first transaction operation identifier and performing a transaction on all “Insert” and “Delete” conclusion set entries between the first and second identifiers; and
migrating the second transaction operation identifier from the high level conclusion set to the two or more low level conclusion sets whilst maintaining the transaction operation identifiers in chronological order of insertion within each conclusion set and between levels of conclusion sets.

5. The method of claim 4 wherein the second identifier commits all “Insert” and “Delete” conclusion set entries between the first and second identifiers.

6. The method of claim 4 wherein the second identifier drops, undoes, or rolls back all “Insert” and “Delete” conclusion set entries between the first and second identifiers.

7. The method of claim 1 wherein the high level conclusion set contains two or more conclusion set entries, and during each migration step the two or more conclusion set entries are split and migrated to two or more low level conclusion sets within a single level of the hierarchical structure.

8. The method of claim 1 wherein the “Delete” entry includes an associated key, and data specifying the “Insert” entry.

9. A method of querying a database index with a key, the index comprising a hierarchical structure of conclusion sets arranged in a series of levels, each conclusion set containing one or more conclusion set entries, the conclusion set entries being in chronological order of insertion within each conclusion set and between levels of conclusion sets, the method comprising:
navigating the database index to retrieve a “Delete” conclusion set entry which is associated with the key; and
returning no result associated with at least one “Insert” conclusion set entry which is associated with the key and chronologically earlier than the “Delete” conclusion set entry.

10. The method of claim 4-09 further comprising:
navigating the database index to its lowest level;
retrieving a further “Insert” conclusion set entry associated with the key; and
returning a result associated with the further “Insert” conclusion set entry.

11. A computer program product for causing a data processor to implement the method of claim 1.

12. A database index maintained by the method of claim 1.

13. A database system comprising:
an index maintained by the method of claim 1; and
a query engine configured to query the index comprising a hierarchical structure of conclusion sets arranged in a series of levels, each conclusion set containing one or more conclusion set entries, the conclusion set entries being in chronological order of insertion within each conclusion set and between levels of conclusion sets by a method comprising:
navigating the database index to retrieve a “Delete” conclusion set entry which is associated with the key; and
returning no result associated with at least one “Insert” conclusion set entry which is associated with the key and chronologically earlier than the “Delete” conclusion set entry.
